(19) United States
(12) Patent Application Publication
(10) Pub. No.: US 2008/0005538 A1
(43) Pub. Date: Jan. 3, 2008

(54) Dynamic configuration of processor core banks

(76) Inventors: Padmashree K. Apparao, St. Portland, OR (US); Ravindra V. Velhal, Beaverton, OR (US)

Correspondence Address: Attorney for INTEL CORP.;Buckley, Maschoff & Talwalkar LLC, Five Elm Street, New Canaan, CT, 06840, US

(21) Appl. No.: 11/479,573

(22) Filed: Jun. 30, 2006

(51) Int. Cl. G06F 15/00

(52) U.S. Cl. 712/220

(57) ABSTRACT

A method may comprise determining a first reliability rank associated with a first processor core, determining a second reliability rank associated with a second processor core, and associating the first processor core and the second processor core with a first processor core bank. The association of the first processor core and the second processor core is based on the first reliability rank and the second reliability rank.

### BACKGROUND

A multi-core platform includes two or more processor cores. Such a platform may assign applications to its processor cores based on any number of conventional algorithms. Over time, as the platform is used, each processor core may age or wear differently, resulting in differences in reliability among the processor cores of the platform. Conventionally, these differences in reliability are not considered when assigning applications to processor cores.

### BRIEF DESCRIPTION OF THE DRAWINGS

FIG. 1 illustrates a system according to some embodiments.

FIG. 2 comprises a flow diagram of a process according to some embodiments.

FIG. 3 illustrates a system according to some embodiments.

FIG. 4 illustrates a system according to some embodiments.

FIG. 5 is tabular representation of a portion of a database according to some embodiments.

FIG. 6 comprises a flow diagram of a process according to some embodiments.

### DETAILED DESCRIPTION

The several embodiments described herein are solely for the purpose of illustration. Embodiments may include any currently or hereafter-known versions of the elements described herein. Therefore, persons in the art will recognize from this description that other embodiments may be practiced with various modifications and alterations.

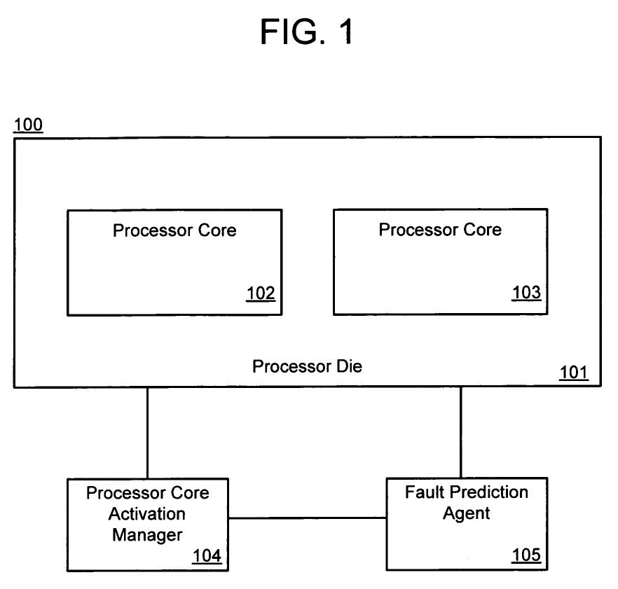

Referring to FIG. 1, an embodiment of a system 100 is shown. The system 100 may comprise a processor die 101, a fault prediction agent 105, and a processor core activation manager 104. The processor die 101 may include a first processor core 102 and a second processor core 103. The system 100 may comprise any electronic system, including, but not limited to, a desktop computer, a server, and a laptop computer. Moreover, the processor die 101 may comprise any integrated circuit die that is or becomes known.

For purposes of the present description, each of the processor cores 102 and 103 comprise systems for executing program code. The program code may comprise one or more software applications. Each of the processor cores 102 and 103 may include or otherwise be associated with dedicated registers, stacks, queues, etc. that are used to execute program code and/or one or more of these elements may be shared there between.

The fault prediction agent 105 may acquire data associated with each processor core 102, 103. The acquired data may provide an indication of the reliability of each processor core 102, 103. For example, the fault prediction agent 105 may acquire statistical information and core reliability metrics associated with each processor core 102, 103. The fault prediction agent 105 may acquire the data from registers, such as, but not limited to a debug register and a model specific register. In some embodiments, the data may be acquired during a system reset. The data acquired by the fault prediction agent 105 may be used by the processor core activation manager 104 as described below.

The fault prediction agent 105 may also determine a reliability rank associated with each processor core 102, 104 based on the acquired data. In some embodiments, the reliability rank may comprise a rank based on an individual processor core's probability of experiencing a fault. According to some embodiments, the reliability rank may comprise a function of one or more of a processor core component fault history, a degradation of the processor core measured by the number of hours of operation, a number of faults, frequency drift, and voltage and power susceptibility.

The processor core activation manager 104 may associate each processor core 102, 103 with a respective processor core bank based on each processor core's reliability rank. A processor core bank may comprise a logical grouping of processor cores based on specific criteria such as, but not limited to, reliability, speed, wear, performance, and a probability to fail. A processor core bank may comprise processor cores associated with one or more processor die.

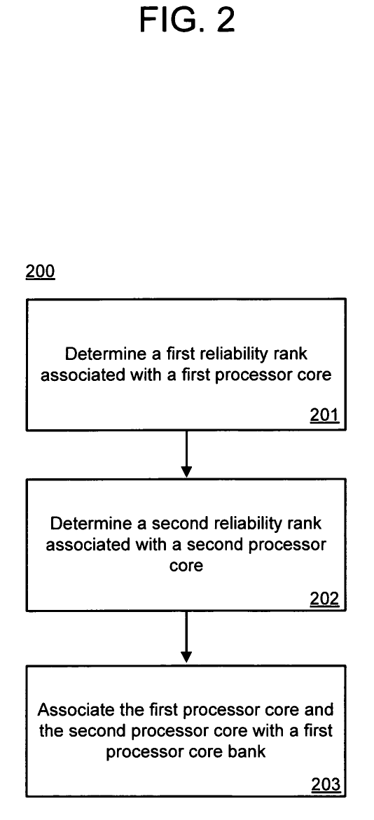

Now referring to FIG. 2, an embodiment of a process 200 is shown. Process 200 may be executed by any combination of hardware, software, and firmware, including but not limited to the system 100 of FIG. 1. Some embodiments of process 200 may improve system reliability and stability.

At 201, a first reliability rank associated with a first processor core is determined. According to some embodiments of 201, the fault prediction agent 105 acquires a first data associated with the first processor core 102 and determines the first reliability rank based thereon. The first data may comprise statistical information to predict a likelihood of a processor core fault, and the first reliability rank may comprise an integer between 0 and 10. Any other convention may be used to represent the first reliability rank.

At 202, a second reliability rank associated with a second processor core is determined. Continuing with the present example, the fault prediction agent 105 may extract a second data associated with the second processor core 103 and may determine the second reliability rank. The first and second reliability ranks, in some embodiments, may be stored in association with their respective processor cores.

The first processor core and the second processor core are associated with a first processor core bank at 203. The processor core activation manager 106 may associate the first processor core and the second processor core with a first core bank based on the first data and the second data. In some embodiments, the processor cores may be associated with the first processor core bank during a system reset. The association at 203 may comprise associating the first processor core and the second processor core with an indicator of the first processor core bank in a database.

In some embodiments of 203, the processor core activation manager 106 may associate processor cores of higher reliability ranks with a first processor core bank and may associate processor cores of lower reliability ranks with a second processor core bank. Associating processor cores with processor core banks based on reliability ranks may improve system reliability and stability.

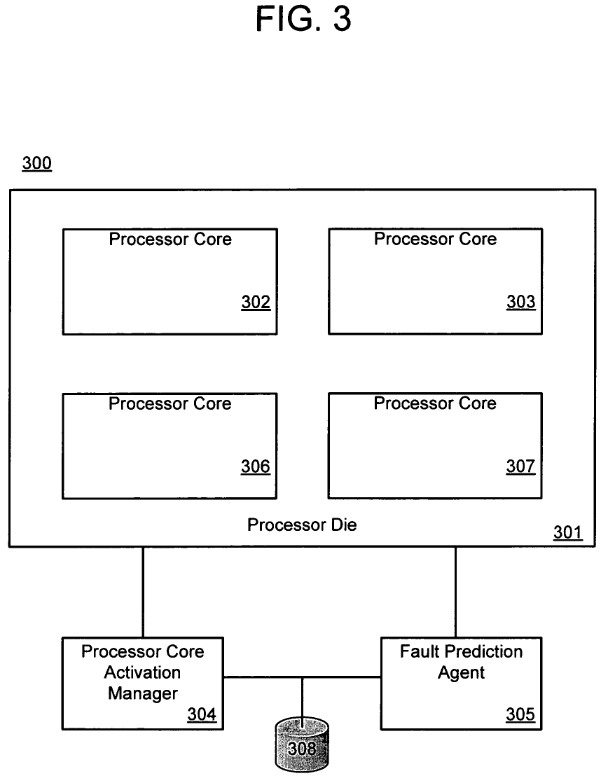

FIG. 3 illustrates a system 300 according to some embodiments. The system 300 may implement process 200 according to some embodiments. The system 300 may include a processor die 301, a processor core activation manager 304, a fault prediction agent 305, and a database 308. The processor die 301 may include one or more processor cores 302, 303, 306, and 307.

The fault prediction agent 305 may acquire data associated with each processor core 302, 303, 306, 307. The acquired data may comprise any of the types of data discussed above. In some embodiments, the data is acquired during a system reset. According to some embodiments, the fault prediction agent 305 may acquire the data in response to a request from the processor core activation manager 304. The fault prediction agent 305 may transmit the data associated with each processor core 302, 303, 306, 307 to the processor core activation manager 304.

The database 308 may comprise, but is not limited to, magnetic media, optical media, or non-volatile memory. The database 308 may store data associated with the first core 302, the second core 303, the third core 306, and the fourth core 307. In some embodiments, the fault prediction agent 305 stores the data in the database 308 and the processor core activation manager 304 requests and receives the data from the database 308.

The processor core activation manager 304 may determine a reliability rank associated with each respective processor core 302, 303, 306, 307 based on each processor core's respective data and may associate one or more of the processor cores 302, 303, 306, 307 with a first processor core bank based on each processor core's respective reliability rank. For example, the first processor core 302 and the fourth processor core 307 may be associated with a first processor core bank based on their high reliability ranks and the second processor core 303 and the third processor core 306 may be associated with a second processor core bank based on their low reliability ranks.

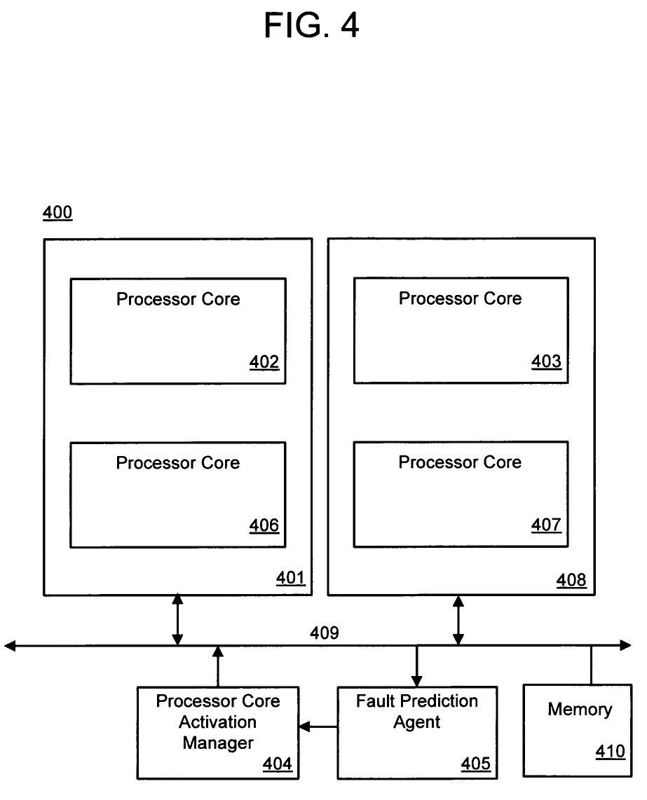

Now referring to FIG. 4,a system 400 according to some embodiments is illustrated. The system 400 may also implement process 200 according to some embodiments. The system 400 may include a first processor die 401, a second processor die 408, a processor core activation manager 404, a memory 410, and a fault prediction agent 405. The first processor die 401 may include one or more processor cores 402, 406 and the second processor die 408 may include one or more processor cores 403, 407. The elements of FIG. 4 may function similarly to their identically-named counterparts described above. A primary difference between system 400 and the systems mentioned above is the presence of two processor die 401, 408, each of which is a multi-core processor.

The memory 410 may store, for example, applications, programs procedures, and/or modules of instructions to be executed. The memory 410 may comprise, according to some embodiments, any type of memory for storing data, such as a Single Data Rate Random Access Memory (SDR-RAM), a Double Data Rate Random Access Memory (DDR-RAM), or a Programmable Read Only Memory (PROM).

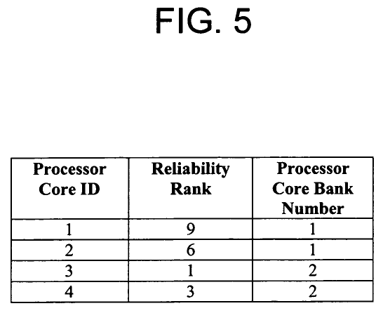

FIG. 5 illustrates a tabular representation of a portion of a database. In some embodiments, the tabular representation may associate processor cores with their respective reliability rank and processor core bank. The illustrated reliability ranks may be acquired by a fault prediction agent and the processor core banks may be assigned by a processor core activation manager according to some embodiments. The data of FIG. 5 may be represented by any alphanumeric character, symbol, or combination thereof and may be expressed in any suitable units.

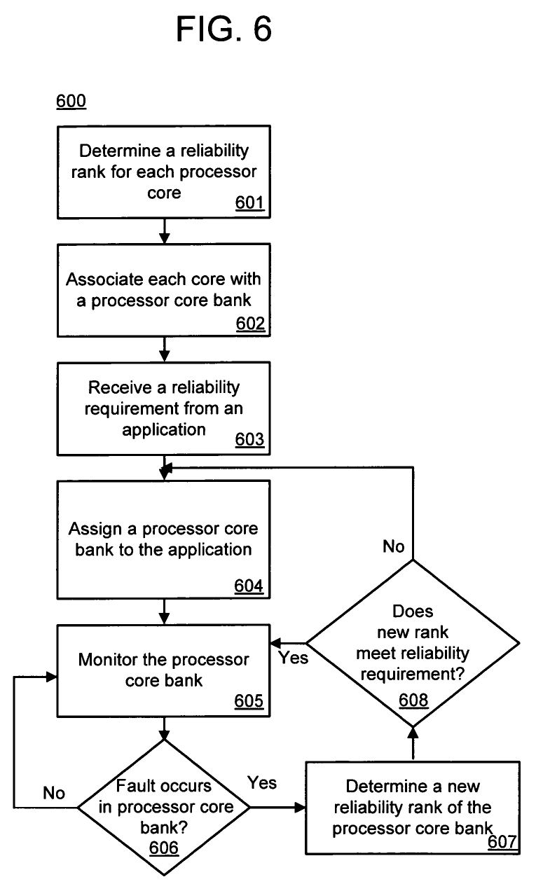

At FIG. 6, a flow diagram of a process 600 according to some embodiments is shown. Process 600 may be executed by any of systems 100, 300 and 400 described above, but embodiments are not limited thereto. Any platform including two or more processor cores may execute process 600.

At 601, a reliability rank is determined for each of two or more processor cores. With respect to the example of FIG. 3, the fault prediction agent 305 may determine the reliability ranks for each of processor cores 302, 303, 306 and 307 at 601. The determination at 601 may occur periodically or based on an event such as system reset, and may be based on data acquired by the fault prediction agent 305 from processor cores 302, 303, 306 and 307. As described above, the data may comprise any data based on which a reliability of a processor core may be surmised. The fault prediction agent 305 may store the determined reliability ranks in the database 308 as illustrated in FIG. 5.

Each processor core is associated with a processor core bank at 602. Continuing with the present example, the processor core activation manager 304 associates each of processor cores 302, 303, 306 and 307 with a processor core bank based on the reliability ranks stored in the database 308. According to the embodiment illustrated in FIG. 5, processor core 1 and processor core 2 are associated with high reliability ranks and are therefore associated with processor core bank 1. Processor core 3 and processor core 4 are associated with lower reliability ranks are associated with processor core bank 2.

Next, at 603, a reliability requirement associated with an application is received. The reliability requirement may comprise an indication of processor core reliability that is required by an application to be executed by the system 300. The reliability requirement may be received from the application itself, from an operating system of the system 300, and/or via any other suitable mechanism. The reliability requirement may be received at 603 by the processor core activation manager 304 or by the fault prediction agent 305.

At 604, a processor core bank is assigned to the application. In some embodiments of 604, the processor core activation manager 304 may assign a processor core bank that meets the received reliability requirement to the application. For example, if the reliability requirement requires high reliability, then the processor core activation manager 304 may assign processor core bank 1 of FIG. 5 to the application. The processor core bank may then be used to execute the application.

The processor core bank is monitored at 605. For example, the fault prediction agent 305 may monitor each processor core within processor core bank 1 for faults or statistical information that may indicate a fault. In some embodiments, the fault prediction agent 305 may continuously monitor each processor core. According to some embodiments, the fault prediction agent 305 may monitor or poll each processor core at predetermined intervals.

At 606, it is determined whether any faults have occurred within the processor core bank. If not, the assigned processor core bank may continue to execute the application and flow returns to 605 to continue monitoring the processor core bank. If a fault has occurred, then, at 607, a new reliability rank is determined for each core within the processor core bank. Determination of the new reliability ranks may proceed as described above with respect to 601.

At 608, it is determined, based on the new reliability ranks, whether the processor core bank still meets the reliability requirement associated with the application. If not, flow returns to 605 and proceeds as described above. If the processor core bank no longer meets the reliability requirement, then the processor core activation manager 304 assigns a new processor core bank to the application at 604.

In some embodiments, if a processor core is determined to be faulty or have a high likelihood to fail, the processor core activation manager may disassociate the faulty core from the processor core bank. In some embodiments, the processor core activation manager may associate a new processor core with a processor bank after disassociating a faulty processor core.

Various modifications and changes may be made to the foregoing embodiments without departing from the broader spirit and scope set forth in the appended claims.

What is claimed is:

1. A method comprising:
determining a first reliability rank associated with a first processor core;
determining a second reliability rank associated with a second processor core; and
associating the first processor core and the second processor core with a first processor core bank based on the first reliability rank and the second reliability rank.

2. The method of claim 1, wherein determining the first processor core, determining the second processor core, and associating the first processor core and the second processor core with a processor core bank occur during a system reset.

3. The method of claim 1, wherein the second reliability rank is substantially the same as the first reliability rank.

4. The method of claim 1, wherein the first processor core is within a first processor die and the second processor core is within a second processor die.

5. The method of claim 1, wherein the first reliability rank and the second reliability rank are determined by a fault prediction agent.

6. The method of claim 3, wherein the second reliability rank is greater than the first reliability rank.

7. The method of claim 1, further comprising:
determining a third reliability rank associated with a third processor core;
determining a fourth reliability rank associated with a fourth processor core; and
associating the third processor core and the fourth processor core with a second processor core bank based on the third reliability rank and the fourth reliability rank.

8. The method of claim 1, further comprising:
determining that the first processor core is faulty;
disassociating the first processor core from the first processor core bank; and
associating a third processor core with the first processor core bank.

9. The method of claim 1, further comprising:
receiving a reliability requirement associated with a first application;
associating the first processor core bank with the first application; and
executing the first application using the first processor core bank.

10. The method of claim 9, further comprising:
determining that a fault has occurred in the first processor core bank;
determining a new reliability rank for each processor core associated with a processor core bank; and
determining if the reliability requirement is satisfied based on the new reliability rank.

11. The method of claim 10, further comprising
determining a third reliability rank associated with a third processor core if the reliability requirement is not satisfied;
associating the third processor core with a first processor core bank; and
disassociating the first processor core with the first processor core bank.

12. A system comprising:
a first processor core;
a second processor core;
a processor core activation manager to associated the first processor core and the second processor core with a first processor core bank; and
a fault prediction agent, wherein the fault prediction agent determines a first reliability rank associated with the first processor core and determines a second reliability rank associated with the second processor core.

13. The system of claim 12, wherein the first processor core is within a first processor die and the second processor core is within a second processor die.

14. The system of claim 12, wherein the processor core activation manager is to associate the first processor core and the second processor core with a first processor core bank during a system reset.

15. The system of claim 12, wherein
the fault prediction agent is to receive a reliability requirement associated with a first application,
the processor core activation manager is to associate the first processor core bank with the application; and
the first processor core bank is to execute the first application.

16. The system of claim 15, wherein:
the fault prediction agent is to determine that a fault has occurred in the first processor core bank;
the processor core activation manager is to determine a new rank for each processor core associated with a processor core bank; and
the fault prediction agent is to determine if the reliability requirement is satisfied based on the new rank.

17. A system comprising:
a double rate data memory module;
a first processor core;
a second processor core;
a processor core activation manager to associated the first processor core and the second processor core with a first processor core bank; and
a fault prediction agent, wherein the fault prediction agent determines a first reliability rank associated with the first processor core and determines a second reliability rank associated with the second processor core.

18. The system of claim 17, wherein
the processor core activation manager is to determine a third reliability rank associated with a third processor core if the reliability requirement is not satisfied;
the processor core activation manager is to associate the third processor core with a first processor core bank; and
the processor core activation manager is to disassociate the first processor core with the first processor core bank.

19. The system of claim 17, wherein the first processor core is within a first processor die and the second processor core is within a second processor die.

20. The system of claim 17, wherein the processor core activation manager is to associate the first processor core and the second processor core with a first processor core bank during a system reset.
